(19) United States
(12) Patent Application Publication
(10) Pub. No.: US 2007/0199463 A1
(43) Pub. Date: Aug. 30, 2007

(54) Method for producing print control strips and method for regulating inking by using print control strips

(75) Inventor: Michael Schonert, Augsburg (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/512,955

(22) Filed: Aug. 30, 2006

(30) Foreign Application Priority Data
Aug. 31, 2005 (DE) 10 2005 041 181.9

(51) Int. Cl. B41F 31/02

(52) U.S. Cl. 101/365

(57) ABSTRACT

The method for producing print control strips used for the control of a process of printing an image, which has several inking zones, using at least one scale color includes providing for each inking zone of the image to be printed data from a prepress stage, evaluating the data from the prepress stage thereby checking for each inking zone whether an ink consumption for any of the scale colors in the image to be printed lies below a threshold value, and printing the print control strip in each inking zone without the or each scale color, whose ink consumption in the inking zone of the image to be printed lies below the threshold value, thus adapting the print control strip to the image to be printed.

### BACKGROUND OF THE INVENTION

The invention relates to a method for producing print control strips for the control or regulation of a printing process. Furthermore, the invention relates to a method for regulating inking.

In the printing units of a press, partial print images in the printing inks involved in the printing are applied to a material. During autotypical overprinting, as a rule the four scale colors black, magenta, cyan and yellow and, if appropriate, special colors are printed. For each of these colors, at least one separate printing unit and therefore inking unit has to be provided. The inking unit of each printing unit has an ink metering device, the ink metering device comprising a number of inking zone setting elements corresponding to the number of inking zones in the image to be printed. The inking zone setting elements are also designated ink slides or ink blades. Depending on the setting of the inking zone setting elements, printing ink is applied to the material. The color configuration of a printed product to be printed is defined in a prepress stage, as it is known. There, zonal area coverage values, which ultimately determine the setting of the inking zone setting elements, are defined for all the printing inks to be printed and therefore for all the inking units of the press involved in the printing.

From the prior art, it is already known to measure the inking established on the material during the printing and, on this basis, to regulate the zonal inking of the inking units involved in the printing. To this end, print control strips printed outside the actual image are measured, and these determined actual values of the zonal inking are transmitted to a control device of the press. In the control device, the actual values are compared with predefined desired values in order to generate actuating signals for the inking zone setting elements on the basis of the comparison between the actual values and the desired values and therefore on the basis of the control deviation.

According to the prior art, in order to regulate or control a printing process, print control strips are used which are specific to a printing press or specific to a print shop and are therefore independent of the printed product to be printed. Print control strips of this type either comprise at least one print control bar extending over a plurality of inking zones, or the print control strips are assembled from a plurality of print control elements for each inking zone. The print control strips are independent of the printed product to be printed or the subject to be printed and are accordingly suitable for a large number of different print jobs. When such print control strips independent of the subject to be printed are used, there is the problem that, depending on its configuration, a printed image contains a non-uniform ink distribution, in particular in such a way that, in individual inking zones, certain printing inks are not printed or are printed only to a low extent. In this case, the correct printing in particular of print control strips which are formed by overprinting a plurality of printing inks presents difficulties, which means that the quality of the inking that can be achieved by measuring such print control strips can also be impaired.

### SUMMARY OF THE INVENTION

It is an object of the present invention to provide a novel method for producing print control strips for the control or regulation of a printing process.

According to a preferred embodiment of the invention, for each inking zone of an image to be printed, data from a prepress stage are evaluated in order to produce a print control strip adapted to the printed image. For this purpose a check is made for each inking zone as to whether, for at least one of the scale colors to be printed, the ink consumption lies below a threshold value. When the ink consumption for at least one of these scale colors lies below the threshold value, the print control bar covering the corresponding inking zone or the print control elements of this inking zone is or are independent of the or each scale color whose ink consumption lies below the threshold value, i.e. the print control strip in this area is printed without this respective color.

In order to provide a print control strip adapted to the subject to be printed, it is proposed to check for each inking zone whether the ink consumption for at least one of the scale colors to be printed lies below a threshold value. If this is the case, then the print control strip, at least for the inking zone, is adapted in such a way that the same is independent of the respective scale color whose ink consumption lies below the threshold value. In this way, the printing quality of the print control strip and therefore the control quality that can be achieved with the print control strip can be increased.

According to an advantageous development of the invention, a print control strip is predefined is a gray balance print control bar extending over all the inking zones and formed by overprinting the scale colors cyan, magenta and yellow; when, during the evaluation of the prepress stage data, it is determined for at least one inking zone that the ink consumption for at least one of the scale colors cyan, magenta and yellow lies below the threshold value, in the respective inking zone the gray balance print control bar is interrupted and, in the respective inking zone, the interrupted gray balance print control bar is supplemented, at least in some sections, by a print control bar formed only from the scale color black. Then, the predefined print control bar with the supplemental modifications is printed.

The method according to the invention for regulating the inking is carried out by using the print control strip produced according to the invention.

Further developments of the invention emerge from the dependent claims and the following description.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention, without being restricted thereto, will be explained in more detail with reference to the drawings.

FIG. 1 is a detailed schematic view of a print control strip which is assembled from four print control elements for each inking zone,

FIG. 2 is a detailed schematic view of a print control strip which is assembled from two print control bars extending over a plurality of inking zones,

FIG. 3 is a detailed schematic view of a print control strip which is assembled from two print control elements for each inking zone,

FIG. 4 is a schematic view of a subject to be printed together with a print control strip known from the prior art, which is assembled from two print control bars extending over all the inking zones, and

FIG. 5 is a schematic view of a subject to be printed together with a print control strip produced in accordance with the invention.

### DETAILED DESCRIPTION OF THE PRESENTLY PREFERRED EMBODIMENTS

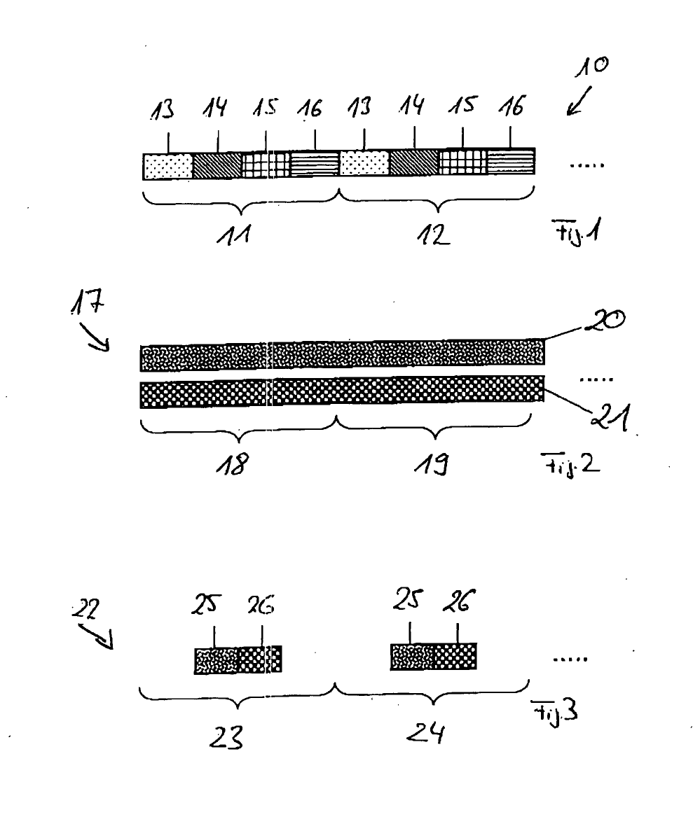

FIG. 1 shows the structure of a print control strip 10 known from the prior art in the region of two inking zones 11 and 12, the print control strip 10 in each inking zone 11, 12 being assembled from four print control elements 13, 14, 15 and 16. Each of the print control element 13, 14, 15 and 16 extends in one of the inking zones 11 and 12 in each case. In FIG. 1, the print control elements 13, 14, 15 and 16 are in each case formed only from one of the scale colors cyan, magenta, yellow and black used in autotypical overprinting.

In the print control strip 10 shown in FIG. 1, the print control elements 13 depend exclusively on the scale color cyan, the print control elements 14 depend exclusively on the scale color magenta, the print control elements 15 depend exclusively on the scale color yellow, and the print control elements 16 depend exclusively on the scale color black or are printed exclusively from these scale colors. The print control elements 13 to 16 of the print control strip 10 are accordingly what are known as full-tone fields of the respective scale colors, the area coverage of which can be, for example, 50% or even 100%.

FIG. 2 shows a further structure of a print control strip 17 known from the prior art in the region of two inking zones 18, 19, the print control strip 17 of FIG. 2 being formed from two print control bars 20 and 21, which each extend over all the inking zones of the subject to be printed. Thus, the print control bar 20 is what is known as a gray balance print control bar, which is formed by overprinting the scale colors cyan, magenta and yellow. The print control bar 21 is a print control bar which depends exclusively on the scale color black or is printed exclusively in the scale color black. The area coverage of the color black determines the gray value in the print control bar 21. As already mentioned, both print control bars 20 and 21 of the print control strip 17 of FIG. 2 extend over all the inking zones of the subject to be printed.

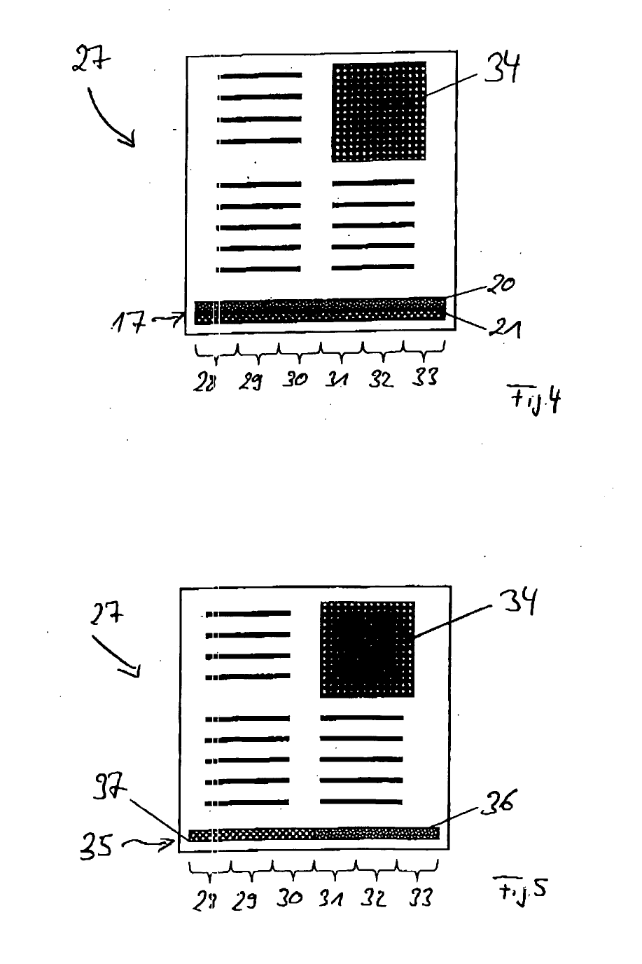

FIG. 3 shows a further configuration of a print control strip 22 known from the prior art in the region of two inking zones 23 and 24, the print control strip 22 in the region of each inking zone 23, 24 being formed from two print control elements 25 and 26. The print control elements 25 are gray balance print control elements which are formed by overprinting the scale colors cyan, magenta and yellow. The print control elements 26, on the other hand, are print control elements which depend exclusively on the scale color black or are printed exclusively from the scale color black.

FIG. 4 shows in schematic form a subject 27 to be printed having six inking zones 28, 29, 30, 31, 32 and 33, the subject 27 being printed by using the print control strip 17 shown in FIG. 2, which is formed from the two print control bars 20 and 21 extending over all the inking zones 28 to 33. In the exemplary embodiment shown in FIG. 4, the subject 27 is, for example, a two-column newspaper page which, in the left-hand printed column, comprises only text in the printing ink black and, in the right-hand printing column, also comprises a colored image 34 which is formed by the autotypical overprinting of the scale colors cyan, magenta, yellow and black.

When the print control strip 17 is used to regulate the zonal inking when printing the subject 27, the problem arises that, in the inking zones 28, 29 and 30 which cover the left-hand column of the subject 27 and in which only the scale color black is printed, there is no ink consumption for the scale colors cyan, magenta and yellow. As a result, difficulties arise in printing the gray balance print control bar 20. This is disruptive in particular in the case of newspaper printing, in which printed print control bars remain on the printed product. Furthermore, if the print control strip cannot be printed correctly, problems can arise in the ink regulation.

According to a preferred embodiment of the present invention, a method for producing print control strips which depend on the printed image to be printed or the subject to be printed is now proposed. To this end, for each inking zone a check is made as to whether, for at least one of the scale colors to be printed, the ink consumption lies below a threshold value. If this is the case, then the print control strip covering the respective inking zone is modified in such a way that, in this inking zone, the same is independent of the scale color whose ink consumption lies below the threshold value.

In the exemplary embodiment of FIG. 5, in order to produce a subject-dependent print control strip 35 as a print control strip, a gray balance print control bar which is supposed to extend over all the inking zones 28 to 33 is predefined which is formed by overprinting the scale colors cyan, magenta and yellow. In the inking zones 28, 29 and 30 in which no ink consumption can be determined for at least one of the scale colors cyan, magenta and yellow and in which the ink consumption for the scale colors cyan, magenta and yellow accordingly lies below a threshold value, this gray balance print control bar is interrupted and is supplemented or replaced, at least in some sections, preferably completely, by a print control bar formed exclusively from the scale color black. Thus, FIG. 5 shows that the print control strip 35 formed in accordance with the invention in the inking zones 31, 32 and 33 is assembled from a gray balance print control bar 36 and, in the inking zones 28, 29 and 30, is assembled from a print control bar 37 which is formed exclusively from the scale color black.

The area coverage of black in the print control bar 37 is preferably chosen in such a way that the gray value in the print control bar 37 corresponds to the gray value in the gray balance print control bar 36.

The present invention can of course also be used in the print control strips of FIGS. 1 and 3. For example, the print control elements of the print control strips 10 and 22 of FIGS. 1 and 3 can be adapted according to the present invention on the basis of an analysis of the prepress stage data of the individual inking zones.

For the print control strip 10 of FIG. 1, provision can be made that, when the ink consumption for at least one scale color lies below the threshold value, the corresponding print control element for this scale color is removed.

For the print control strip 22 of FIG. 3, provision can be made that, when the ink consumption for at least one of the scale colors cyan, magenta and yellow lies below a threshold value, the gray balance print control elements 25 are removed.

Here, it is possible to stick to simply removing the gray balance print control elements; otherwise they can also be replaced by print control elements which depend exclusively on the scale color black or are printed exclusively in the scale color black. It is also possible to imagine replacing a gray balance print control element by a print control element from the scale colors cyan, magenta or yellow, the ink consumption of which lies above the threshold value.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for producing print control strips used for controlling a process of printing an image which has several inking zones and which uses a plurality of scale colors, each of the print control strips comprising at least one print control bar extending over a plurality of the inking zones or a plurality of print control elements for each inking zone, the method comprising the steps of:
providing, for each inking zone of the image to be printed, data from a prepress stage;
evaluating the data from the prepress stage and determining, for each inking zone, ones of the scale colors having an ink consumption that lies below a threshold value; and
printing the print control strip in each inking zone without the ones of the scale colors having an ink consumption in said inking zone of the image to be printed that lies below the threshold value, thus adapting the print control strip to the image to be printed.

2. The method of claim 1, wherein the print control strip is a gray balance print control bar which extends over all the inking zones and is formed by overprinting the scale colors cyan, magenta and yellow, said step of printing comprising interrupting the gray balance print control bar in each inking zone in which the ink consumption for at least one of the scale colors cyan, magenta and yellow in the image to be printed lies below the threshold value.

3. The method of claim 2, wherein the step of printing further comprises the step of supplementing the interrupted gray balance print control bar in at least some sections of the respective inking zone by a print control bar formed only from the scale color black.

4. The method of claim 1, wherein the print control strip is assembled from a plurality of print control elements and includes, for each inking zone, one of a gray balance print control bar formed by overprinting the scale colors cyan, magenta and yellow, and a print control element formed exclusively from one of the scale colors cyan, magenta, yellow or black, said method comprising, before said step of printing, removing, in each inking zone, the one of the gray balance print control bar and the print control element, if the ink consumption for at least one of the scale colors cyan, magenta and yellow lies below the threshold value.

5. The method of claim 4, further comprising the step of replacing each gray balance print control element removed by a print control element formed exclusively from the scale color black.

6. A method for regulating zonal inking in at least one inking unit of a printing press used for printing an image which has several inking zones and which uses a plurality of scale colors, said method comprising the steps of:
providing, for each inking zone of the image to be printed, data from a prepress stage;
evaluating the data from the prepress stage and determining, for each inking zone, ones of the scale colors having an ink consumption that lies below a threshold value; and
printing the image and a print control strip outside the image, the print control strip comprising at least one print control bar extending over a plurality of the inking zones or a plurality of print control elements for each inking zone, wherein the printing of the control strip in each inking zone is performed without the ones of the scale colors whose ink consumption in said inking zone of the image to be printed is determined to lie below this threshold value, thereby adapting the print control strip to the image to be printed;
measuring the printed print control strip and determining an actual value of a characteristic of the printed print control strip;
comparing the actual values with predefined desired values; and
generating actuating signals for inking zone setting elements of at least one inking unit on based on the comparison between the actual values and the desired values, thereby regulating the zonal inking by the inking zone setting elements.

7. The method of claim 6, wherein the print control strip is a gray balance print control bar which extends over all the inking zones and is formed by overprinting the scale colors cyan, magenta and yellow, said step of printing comprising interrupting the gray balance print control bar in each inking zone in which the ink consumption for at least one of the scale colors cyan, magenta and yellow in the image to be printed lies below the threshold value.

8. The method of claim 7, wherein the step of printing further comprises the step of supplementing the interrupted gray balance print control bar in at least some sections of the respective inking zone by a print control bar formed only from the scale color black.

9. The method of claim 6, wherein the print control strip is assembled from a plurality of print control elements and includes, for each inking zone, one of a gray balance print control bar formed by overprinting the scale colors cyan, magenta and yellow, and a print control element formed exclusively from one of the scale colors cyan, magenta, yellow or black, said method comprising, before said step of printing, removing, in each inking zone, the one of the gray balance print control bar and the print control element, if the ink consumption for at least one of the scale colors cyan, magenta and yellow lies below the threshold value.

10. The method of claim 9, further comprising the step of replacing each gray balance print control element removed by a print control element formed exclusively from the scale color black.
